(19) United States
(12) Patent Application Publication
(10) Pub. No.: US 2026/0035177 A1
(43) Pub. Date: Feb. 5, 2026

(54) Container Rack Latch System

(71) Applicant: New AeroFarms, Inc., Ringgold, VA (US)

(72) Inventors: John Koniski, New York, NY (US); Richard Canny, Roseville, MI (US); Husein Delic, Roseville, MI (US)

(73) Assignee: New AeroFarms, Inc., Ringgold, VA (US)

(21) Appl. No.: 19/149,042

(22) PCT Filed: Apr. 18, 2023
(86) PCT No.: PCT/US2023/018927

§ 371 Date: Jul. 17, 2025

Related U.S. Application Data
(60) Provisional application No. 63/331,919, filed on Apr. 18, 2022.

(51) Int. Cl. B65G 1/02; A01G 31/06; B65G 1/04

(52) U.S. Cl. CPC B65G 1/023; A01G 31/06; B65G 1/04

(57) ABSTRACT

A container rack latch system is provided that can retain and index containers into and within a rack. The container rack latch system can include a container supporting surface, a first gate at a proximal end of the system and a second gate spaced from the proximal end of the system. The gates can be configured to operate in an extended orientation to prevent transfer of a container positioned on the container supporting surface into or out of the rack. The gates can be configured to operate in a retracted orientation to permit transfer of a container out of the rack or transfer further into the rack and beyond the spaced gates. The container rack latch system can be a part of a container transfer system that can include a container transfer carriage for moving containers into and away from the supporting surface of the container rack latch system.

### CROSS-REFERENCE TO RELATED APPLICATIONS

This application claims the benefit of a co-pending, commonly assigned U.S. Provisional Patent Application No. 63/331,919, which was filed on Apr. 18, 2022. The entire content of the foregoing provisional application is incorporated herein by reference.

### BACKGROUND

Vertical aeroponic and/or hydroponic systems can include rack and tower structures for support of growing containers and lighting for developing plants. These systems can have multiple levels, have numerous containers on each level, and can have the racks or tower structures closely spaced in rows within a growing facility. Securely positioning large containers within a rack or tower provides reliable operation of the aeroponic and/or hydroponic systems and can eliminate system downtime to free containers that become jammed or misaligned as they are translated within the rack. There is a continuing need for container rack and tower systems that support translatable containers and facilitate their secure transfer into and away from the rack or tower.

### SUMMARY

Embodiments of the present disclosure provide a container rack latch system capable of retaining and indexing one or more containers into and within a rack or tower. The container rack latch system can include a container supporting surface, a first gate and a second gate spaced from the first gate of the system by a distance greater than the length of the container. The gates can be configured to operate in an extended orientation that prevent transfer of a container positioned on the container supporting surface away from a position between the spaced gates into or out of the rack. The gates can be configured to operate in a retracted orientation that permits transfer of the container out of the rack or further into the rack and beyond the gates. The container rack latch system can be used in a container transfer system that can include a container transfer carriage having manipulators that can move containers into and away from the supporting surface of the container rack latch system.

A rack in embodiments of the disclosure can refer to a framework, typically with rails, bars, and other framing members connected together that can provide storage and housing of containers within the rack. A tower in embodiments of the disclosure can refer to a tall structure, such as a rack with one or more levels or a stack of racks, that can house containers. The containers housed in the racks and towers can be used for storage, shipping, or for growing plants in vertical farming systems. Embodiments of the disclosure include a container rack latch system and a container tower latch system (herein after referred to as “a container rack latch system) that provides for the transfer of containers into and away from the rack or tower as well as positioning, storage, and housing of containers therein. The containers housed in the racks and towers can be used for storage, shipping, or for growing plants in vertical farming systems. Aeroponic and hydroponic grow systems can be configured as racks or towers. The terms rack and tower can be used interchangeably throughout the disclosure.

In some embodiments of the disclosure, the container rack latch system includes gates that can be configured to rotate between the retracted and extended positions. The gates can be linked together in pairs whereby the gates of a pair move between extended or retracted positions together. In some embodiments of the disclosure the gates in a pair can be linked physically or electronically to extend or retract together. In some embodiments of the disclosure the gates in a pair can be linked physically by a rotatable shaft. Based on such linkage, the gates can rotate simultaneously as a pair, and the gates rotate simultaneously as a pair.

In some other embodiments of the disclosure, the container rack latch system can include the first gate and second gate that are configured to operate between the retracted and extended positions and can further include a third gate and a fourth gate that are configured to operate between the retracted and extended positions. The third and fourth gates can be linked together by a rotatable shaft. The first and second gates can be separated from the third and fourth gates by a first or proximal end support and a second end support spaced from the first end support. In the extended position, the gates prevent movement of a container off from the supporting surface or movement of a container onto the supporting surface. In the retracted position, the gate position permits the containers to be moved onto the supporting surface or off from the supporting surface.

In still other embodiments of the disclosure, the container rack latch system can be positioned or mounted within a rack. The container supporting surface positioned within the rack can sloped such that a distance from the supporting surface to a horizontal surface near the second end latch support is greater than a distance from the supporting surface to the horizontal surface near the first end latch support.

In embodiments of the container rack latch system of the disclosure, one or more of the gates can include a force transfer structure on the gate. The force transfer structure can be spaced from a rotational axis of the rotatable shaft. A latch actuator mechanism can interact with the force transfer structure on the gate and can operate to move the gates from the extended position (above container support surface or above top edge of an end support) to the retracted position (below container support surface or below top edge of end support).

Embodiments of the disclosure can include a method of container rack latch system operation that can include the acts or steps of applying a first force (e.g. by a manipulator) to a first container on a support surface of a container rack latch system to translate the first container to a position between gates of the rack latch system with the gates in an extended position and whereby the container free from contact with the gates. The method can further include applying a second force (from a latch actuator mechanism) to a force transfer structure on a proximal gate of the container rack latch system to move the proximal gate and a linked spaced opposing gate from the extended position to a retracted position.

The method of container rack latch system operation in embodiments of the disclosure can further include applying a manipulator force to the first container to transfer the first container along the container support surface of the container rack latch system (580) with the gates in the retracted position.

The method of container rack latch system operation in embodiments of the disclosure can include indexing the containers within the rack. In some embodiments the transfer of the first container into the rack indexes a second container out from between the gates in the retracted position thereby positioning the second container in a non-overlapping position with the gates and the first container between the gates. The position of the first container in the rack can be restricted by moving the gates from the retracted to the extended position. In other embodiments the transfer of the first container away from between the gates at the proximal end of the rack can index a second container from within the rack into a position between the gates. The position of the second container in the rack can be restricted by moving the gates from the retracted to the extended position. The first container can be unmated from the second container between the gates in the extended position.

The method of container rack latch system operation can include retracting the gates using a latch actuator mechanism that can have a lever arm. The lever arm can interact with a force transfer structure on a first gate that can operate to reversibly move the first gate and a linked second gate from an extended position (e.g. above the container support surface or above a first set of container supports (574)) to a retracted position (e.g. at or below container support surface (570) or at or below a first set of container supports (574)).

The method of container rack latch system operation can include the acts or steps of removing or decoupling the first container from a second container. The second container (464) can be positioned by the manipulators in a non-overlapping position between the gates of the rack latch system. The gates can then be extended, restricting movement of the second container between the gates, and then first container can be separated from second container by applying a force to the first container by the manipulator and separating the first container from the second container that is between the extended gates.

In embodiments of the method of container rack latch system operation, extending the gates from the retracted position to the extended position can include disengaging a latch actuator mechanism from the force transfer structure on the proximal gate of a latch system.

Further embodiments of the disclosure can include a method of container rack latch system operation that includes applying a first force to move a first container to fluidly mate the first container with a second container on the supporting surface of the container rack latch system. The second container can be between a first gate and a second gate. The first force can be applied to the first container until a distal end of the second container contacts the second gate spaced from the gate at a proximal end of the container rack latch system. The first force can then be removed or reversed which allows positioning of the second container between the proximal gate and the gate spaced from the proximal end; the second container can be free of contact with gates. The method can further include the subsequent act or step of retracting the gates of the latch system whereby the second container can be translated from between the gates in either direction along the container support surface.

The method of container rack latch system operation can further include applying a force from a latch actuator mechanism to a force transfer structure on a proximal gate of the latch system to move the proximal gate and a linked opposing gate from the extended position to a retracted position. The method can further include translating containers along the container supporting surface.

A still further embodiment of the container rack latch system of the disclosure can include a first gate, a second gate, and a shaft rotatably connecting the first gate with the second gate and separating the first gate from the second gate. The shaft is fixedly coupled to the gates, and allows for the gates to be simultaneously rotated between the extended and retracted positions as a pair. The shaft can pass through an opening in a first or proximal end support and can pass through an opening in a second end support spaced from the first end support. The first gate and the second gate can include a force transfer structure connected to the first gate and positioned separate from a rotational axis of the shaft. In some embodiments the force transfer structure can be a rotatable element.

In embodiments of the container rack latch system, the first gate and the second gate in an extended position can protrude above the container supporting surface (e.g., a plane defined the container supporting surface or a first set of container supports). The first gate and the second gate in a retracted position can be at or below the container support surface (e.g., planes defined by the respective supports or surfaces) or at or below a first set of container supports. In some embodiments of the disclosure, one or more sets of container supports and the support surface can be used interchangeably to refer to a surface that can support a container in the rack latch system and the rack.

The container rack latch system in embodiments of the disclosure can further include a third gate, a fourth gate, and a shaft rotatably connecting the third gate with the fourth gate and separating the third gate from the fourth gate. The shaft is fixedly coupled to the gates, and allows for the gates to be simultaneously rotated between the extended and retracted positions as a pair. The shaft can pass through an opening in a first end support and can pass through an opening in a second end support spaced from the first end support. The third gate can include a force transfer structure that can be connected to the third gate and positioned separately from a rotational axis of the shaft.

In embodiments of the disclosure, one or more of the gates of the container rack latch system can have an uneven distribution of mass about the rotational axis of the shaft that can result in rotation of the gates from a retracted position to an extended position in the absence of an external force applied to the gates to maintain them in the retracted position. In embodiments of the container rack latch system of the disclosure the first gate and the third gate can have a distribution of mass about the rotational axes of the shafts that can cause these gates to rotate from a retracted position with respect to the first end support to an extended position in the absence of an external force applied to the first and third gates.

An embodiment of the disclosure is a container transfer system. The container transfer system can include a container transfer carriage that has a container support surface capable of receiving and transferring a container along the container support surface of the transfer carriage. The container transfer carriage can have one or more manipulators that can engage the container. The one or more manipulators can be moved or translated along a length of the container transfer carriage. The one or more manipulators are adapted to translate the container along the container support surface. The container transfer carriage can optionally have a latch actuator mechanism that can retract and extend gates of a container rack latch system connected to a rack. The rack can be configured to removably receive one or more of the containers from the transfer carriage. The containers can be positioned between the gates on a supporting surface of the container rack latch system. The container transfer carriage, a latch actuator mechanism, which can be on the carriage or the rack latch system, can operate cooperatively to load a container from the container transfer carriage onto the supporting surface of the rack latch system and operate cooperatively to unload the container from the supporting surface to the transfer carriage. In some embodiments of the container transfer system the latch actuator mechanism can reversibly move towards or away from the gate. In some embodiments of the latch actuator mechanism the carriage transfer system can be mounted to the container transfer carriage. In other embodiments of the carriage transfer system the latch actuator mechanism can be mounted to the container rack latch system. In embodiments of the container transfer system, the movement of the manipulator can be independent or synchronized with the movement of the latch actuator mechanism.

Advantages of the embodiments of the disclosure enable positive control of containers by one or more of the transfer carriage manipulators, the gates in a closed or extended position, or a combination of the transfer carriage manipulators and the gates in a closed or extended position. Positive control greatly improves the safety of container transfer. In embodiments where the containers are used in grow systems, embodiments of the disclosure also enable fluid couplings to safely and repeatedly be made and broken during loading and unloading of containers from the rack.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 illustrates a container rack latch system;

FIG. 2 illustrates a container rack latch system;

FIG. 3 illustrates a front view of a container rack latch system;

FIG. 4 illustrates another embodiment of a container rack latch system;

FIG. 5 illustrates aspects of a proximal gate;

FIG. 6 illustrates aspects of retracted gates;

FIG. 7 illustrates aspects of extended gates;

FIG. 8 illustrates a side view of a rack and a container positioned therein;

FIG. 9 illustrates a side view of a rack with two containers positioned therein;

FIG. 10 illustrates schematically the action of the one or more latch actuator mechanisms;

FIG. 11 illustrates schematically the action of the one or more latch actuator mechanisms;

FIG. 12 illustrates schematically the action of the one or more latch actuator mechanisms;

FIG. 13 illustrates schematically the action of the one or more latch actuator mechanisms;

FIG. 14 illustrates schematically the action of the one or more latch actuator mechanisms;

FIG. 15 illustrates schematically the action of the one or more latch actuator mechanisms;

FIG. 16 illustrates schematically the action of the one or more latch actuator mechanisms;

FIG. 17 illustrates schematically the action of the one or more latch actuator mechanisms;

FIG. 18 illustrates schematically the action of the one or more latch actuator mechanisms;

FIG. 19 illustrates schematically the action of the one or more latch actuator mechanisms;

FIG. 20 illustrates schematically the action of the one or more latch actuator mechanisms;

FIG. 21 illustrates schematically the action of the one or more latch actuator mechanisms;

### DESCRIPTION

Embodiments of the disclosure include a container rack latch system that can retain and index one or more containers into and within a rack or tower. The container rack latch system can include a container supporting surface, a first gate at a proximal end of the system and a second gate spaced from the proximal end of the system. The gates can be configured to operate in an extended orientation such that the gates can prevent transfer of a container positioned on the container supporting surface away from between the spaced gates into or out of the rack and rack latch system. The gates can be configured to operate in a retracted orientation that permit transfer of a container out of the rack or permit the transfer of the container further into the rack and beyond the spaced gates. The container rack latch system can be part of a container transfer system that can include a container transfer carriage having manipulators for moving containers into and away from the supporting surface of the container rack latch system.

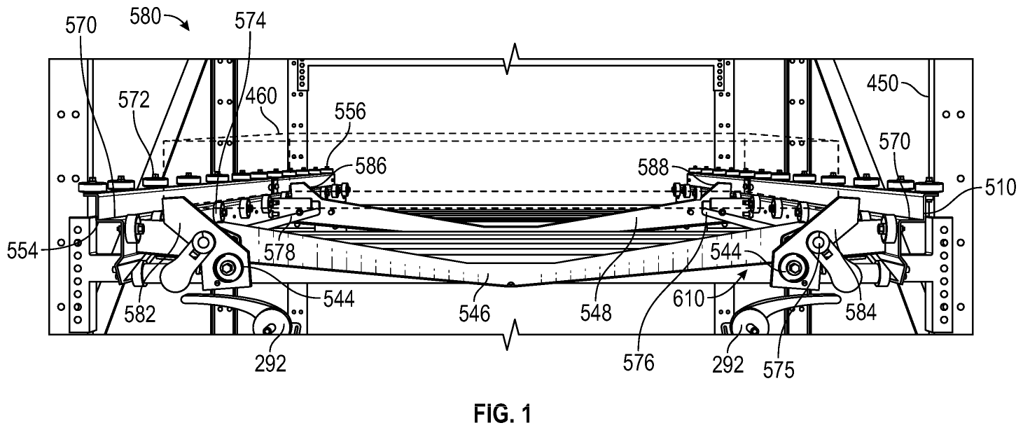

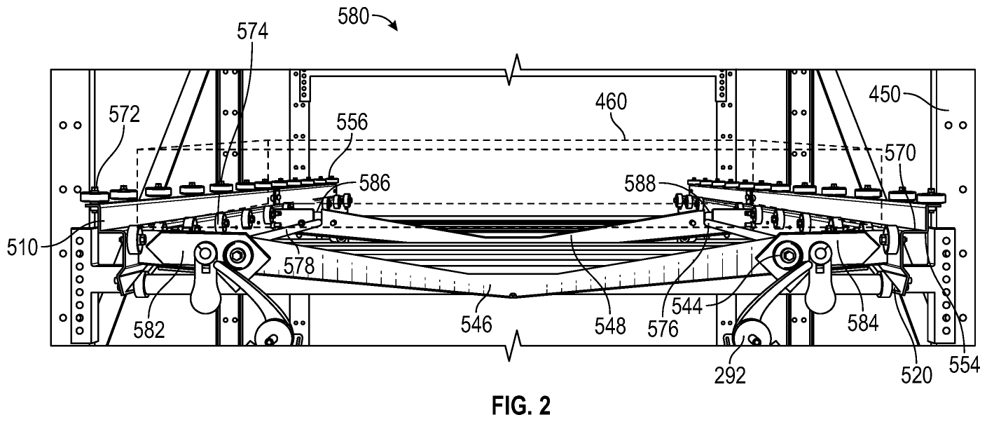

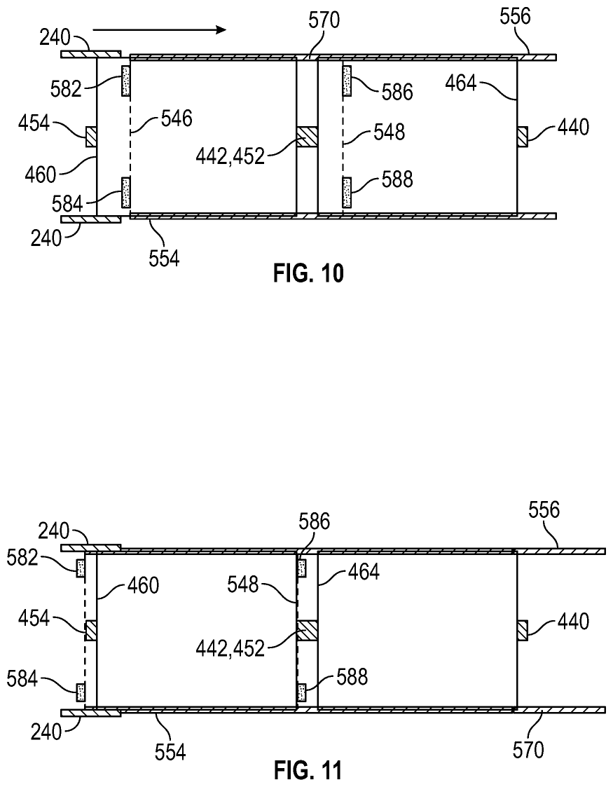

Embodiments of the present disclosure provide a container rack latch system capable of retaining and indexing one or more containers into and within a rack or tower (FIG. 1). The container rack latch system 580 can include a container supporting surface 570, a first gate 584 at a proximal end 554 of the system 580, and a second gate 588 spaced from the proximal end 554 of the system 580 at a rear of the rack latch system 580. The space between gates 584, 588 is greater than the length of a container 460. The gates 584, 588 can be configured to operate in an extended orientation wherein the gates 584, 588 are adapted to prevent transfer of a container 460 positioned on the container supporting surface 570 away from a position between the gates 584. 588 (see, e.g., FIG. 1, and also FIGS. 11, 12, and 14) into or out of the rack. The gates 584, 588 can be configured to operate in a retracted orientation (FIG. 2) wherein the gates 584, 588 are adapted to permit transfer of the container 460 out of the rack or further into the rack and beyond the gates 584, 588 (see, e.g., FIG. 2, FIG. 10, FIG. 13).

A rack in embodiments of the disclosure can refer to a framework, typically with rails, bars, and other framing members connected together that can provide openings for storage and housing of containers within the rack. A tower in embodiments of the disclosure can refer to a tall structure, such as a rack with one or more levels or a stack of racks, that can house containers. The containers housed in the racks and towers can be used for storage, shipping, or for growing plants in vertical farming systems. Embodiments of the disclosure include a container rack latch system and a container tower latch system (herein after referred to as “a container rack latch system) that provides for the transfer of containers into and away from the openings of the rack or tower as well as positioning, storage, and housing of containers therein. The containers housed in the racks and towers can be used for storage, shipping, or for growing plants in vertical farming systems. Aeroponic and hydroponic grow systems can be configured as racks or towers. The terms rack and tower can be used interchangeably throughout the disclosure.

In embodiments of the disclosure having racks or towers with multiple levels, each level of the rack or tower can include a container rack latch system. A container transfer system including a container transfer carriage and a latch actuator mechanism can operate cooperatively to load containers from the container transfer carriage to a supporting surface of the container rack latch system and also operate cooperatively to unload containers from the supporting surface to the carriage.

In some embodiments of the disclosure the container rack latch system 580 includes pairs of gates (e.g. gates 584, 588) that can be configured to rotate between retracted and extended positions. The gates (e.g. gates 584, 588, or gates 582, 586, or the like) can be linked together in pairs (e.g. gates 584, 588, or gates 582, 586, or the like) whereby the gates of a pair move between extended or retracted positions together. In some embodiments of the disclosure the gates in a pair can be linked physically, or electronically, to extend or retract together. In some embodiments of the disclosure the gates in a pair can be linked physically/mechanically by a rotatable latch shaft 576, 578. Based on such linkage, the gates 582, 586 rotate simultaneously as a pair, and the gates 584, 588 rotate simultaneously as a pair.

In some other embodiments of the disclosure, the container rack latch system 580 can have a pair of gates that include a first gate and a second gate 584, 588 that are configured to operate between the retracted and extended positions. The first and second gates 584, 588 can be mechanically linked together by a rotatable shaft 576. In some embodiments the rack latch system 580 can further have additional pairs of gates that can include a third gate and a fourth gate 582, 586 that are configured to operate between the retracted and extended positions. The third and fourth gates 582, 586 can be mechanically linked together by a rotatable shaft 578. The first and second gates 584, 588 can be separated from the third and fourth gates 582, 586 by a first end support 546 and a second end support 548 spaced from the first end support 546. In the extended position, the gates prevent movement of a container 460 off from the supporting surface 570 or movement of a container 460 onto the supporting surface 570. In the retracted position, the gate position permits the containers 460 to be moved onto the supporting surface 570 or off from the supporting surface 570.

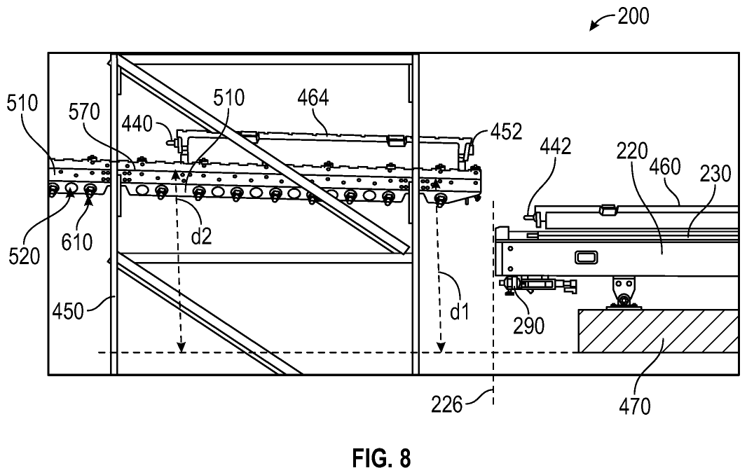

In still other embodiments of the disclosure, the container rack latch system 580 can be positioned or mounted within a rack 450 (see, e.g., FIG. 1). The container rack latch system 580 can include supports 510 that have a container supporting surface 570 on which the container 460 can be translated. The supports 510 can be mounted to the rack 450. The container supporting surface 570 positioned within the rack 450 can be sloped or at an incline 260 such that a distance d2 from the supporting surface 570 to a horizontal surface 470 near the second end latch support 548 is greater than a distance dl from the supporting surface 570 to the horizontal surface 470 near the first end latch support 546 (see, e.g., FIG. 8).

In embodiments of the container rack latch system 580 of the disclosure, one or more of the proximal gates 582, 584 can include a force transfer structure 544. The force transfer structure 544 can be spaced from a rotational axis 575 of the rotatable shaft 576 that can connect pairs of gate (e.g. gates 584, 586). A latch actuator mechanism 290 can interact with the force transfer structure 544 on the proximal gate 584 and operate to move the gates 584, 588 from the extended position wherein a portion of the gates 584, 588 are positioned above the container support surface 570 or a first set of container supports 574 to the retracted position (below surface 570) (see, e.g., FIG. 1 and FIG. 2). A latch actuator mechanism 290 can interact with the force transfer structure 544 on the gate 582 and can operate to move the gates 582, 586 from the extended position wherein a portion of the gates 582, 586 are positioned above container support surface 570 or a set of container supports 574 to the retracted position wherein the gates are below support surface 570 or a set of container supports 574 (see, e.g., FIG. 1 and FIG. 2).

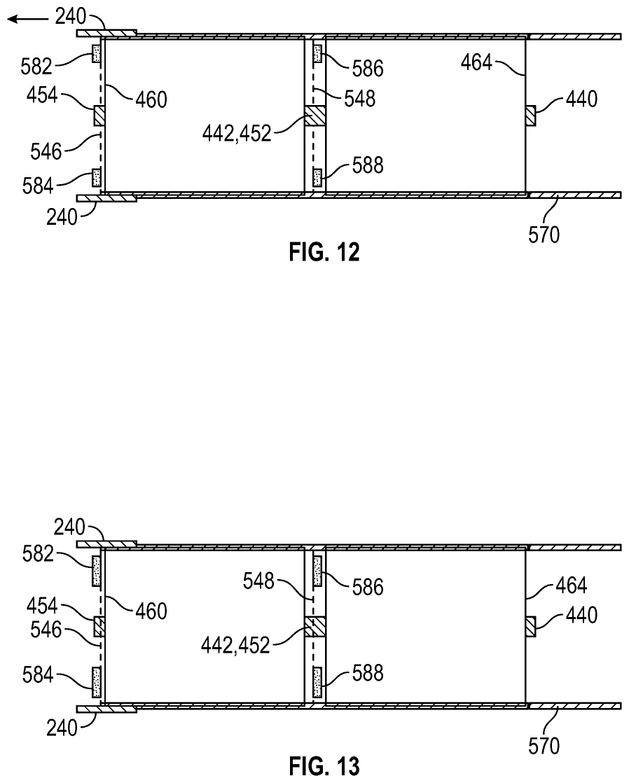

Embodiments of the disclosure can include a method of container rack latch system 580 operation that can include the acts or steps of applying a first force (e.g. by a manipulator 240) to a first container 460 on a support surface 570 of a container rack latch system 580 to translate the first container 460 to a position between gates (e.g. gates 584, 588) of the rack latch system 580 with the gates in an extended position whereby the container is free from contact with the gates (FIG. 12). The method can further include applying a second force (from latch actuator mechanism 290) to a force transfer structure 544 on a proximal gate 584 of the container rack latch system 580 to move the proximal gate 584 and the linked opposing gate 588 from the extended position to a retracted position (see, e.g., FIG. 2, FIG. 13).

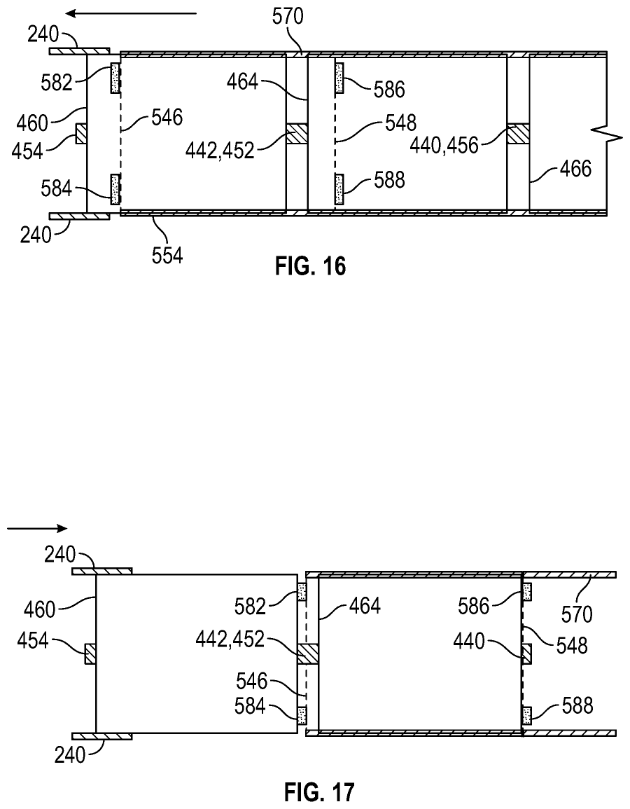

The method of container rack latch system 580 operation in embodiments of the disclosure can further include applying a manipulator force (e.g. by a manipulator 240) to the first container 460 to transfer the first container 460 along the container support surface 570 of the container rack latch system 580 with the gates 584, 588 in the retracted position (see, e.g., FIG. 10 and/or FIG. 16).

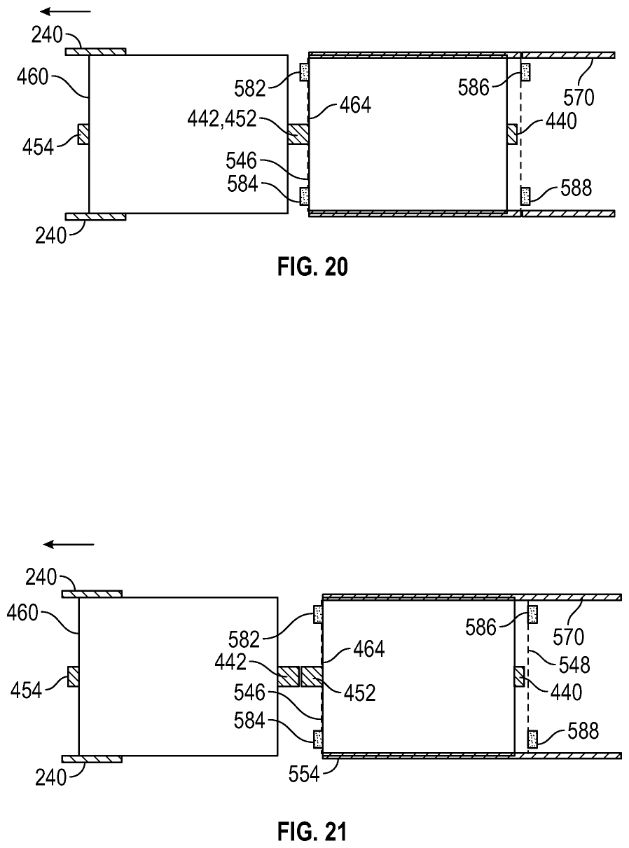

The method of container rack latch system 580 operation in embodiments of the disclosure can include indexing the containers within the rack. In some embodiments the transfer of the first container into the rack indexes a second container out from between the gates in the retracted position (FIG. 10) thereby positioning said second container into a non-overlapping position and not between the gates (FIG. 13) while the first container can be positioned between the gates. The position of the first container in the rack can be restricted by moving the gates from the retracted to the extended position (e.g. FIG. 15). In other embodiments the transfer of the first container 460 away from between the gates at the proximal end of the rack can index a second container 464 from within the rack into a position between the gates. The position of the second container in the rack can be restricted by moving the gates from the retracted to the extended position (FIG. 20). The first container can be unmated from the second container between the gates in the extended position (FIG. 20) by action of the manipulators 240.

The method of container rack latch system 580 operation can include retracting the gates using a latch actuator mechanism 290 that can have a lever arm 292. The lever arm 292 can interact with a force transfer structure 544 on the gate 584 that can operate to reversibly move the gates 584, 588 from the extended position (above container support surface 570 or above a set of container supports 574) to the retracted position (below surface 570 or below a set of container supports 574) (FIG. 1 and FIG. 2).

The method of container rack latch system 580 operation can include the acts or steps of removing (decoupling) the container 460 from a container 464 with the gates in a retracted position from the proximal end of the container rack latch system 580. The container 464 can be positioned by the manipulators in a non-overlapping position with the gates (FIG. 19). The gates can be extended (FIG. 20), restricting movement of the container 464, and container 460 can be separated from container 464 by applying a force (<-) to container 460 and separating the container 460 from the adjacent container 464 that is between the extended gates (FIG. 21).

In embodiments of the method of container rack latch system 580 operation, extending the gates from the retracted position to the extended position can include disengaging a latch actuator mechanism from the force transfer structure 544 on the proximal gate 584 of a latch system 580.

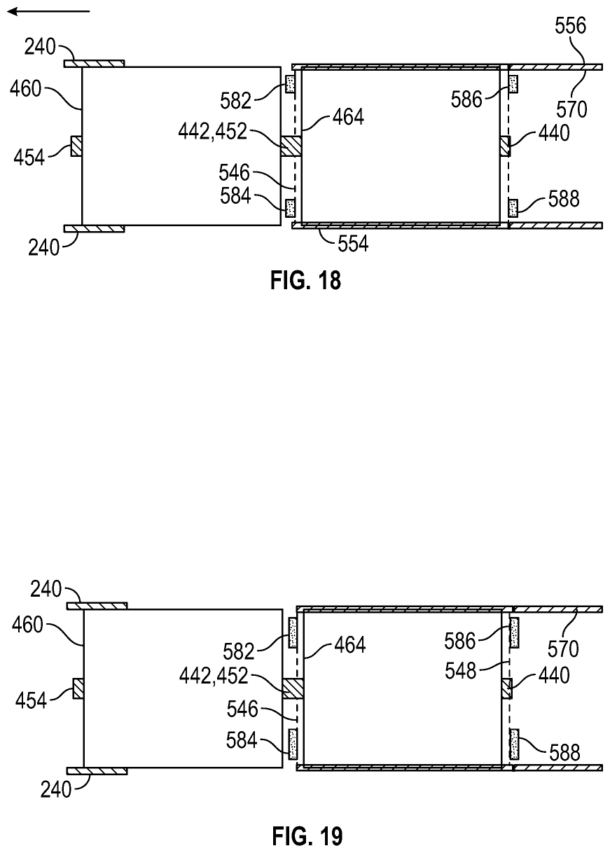

Further embodiments of the disclosure can include a method of container rack latch system 580 operation that includes applying a first force to move a first container 460 to fluidly mate the first container 460 with a second container 464 on the supporting surface 570 of the container rack latch system 580. The second container 464 can be between a first gate 584 and a second gate 588. The first force can be applied to the container 460 until a distal end of the second container 464 contacts the second gate 588 that is spaced from the gate 584 at a proximal end 554 of the container rack latch system 580 whereby the containers 460, 464 are fluidly coupled together. The first force can then be removed or reversed which allows positioning of the second container 464 between the proximal gate 584 and the gate 588 spaced from the proximal end (FIG. 18); the container 464 can be free of contact with gates 584, 588 (FIG. 18). The method can further include the subsequent act or step of retracting the gates 584, 588 of the latch system 580 (FIG. 19) whereby the container 464 can be translated from between the gates further into the rack by pushing containers 460, 464 using the manipulators 240 along the container support surface 570. The method can further include the subsequent act or step of retracting the gates 584, 588 of the latch system 580 (FIG. 19) whereby the container 464 can be translated from between the gates in either direction along the container support surface 570.

The method of container rack latch system 580 operation can further include applying a force from latch actuator mechanism to a force transfer structure 544 on a proximal gate 584 of the latch system 580 to move the proximal gate 584 and the linked opposing gate 588 from the extended position to a retracted position. The method can further include translating containers (e.g. containers 460, 464) along the container supporting surface 570.

A still further embodiment of the container rack latch system 580 of the disclosure can include a first gate 584, a second gate 588, and a shaft 576 rotatably connecting the first gate 584 with the second gate 588 and separating the first gate 584 from the second gate 588. The shaft 576 is fixedly coupled to the gates 584, 588, and allows for the gates 584, 588 to be simultaneously rotated between the extended and retracted positions as a pair. The shaft 576 can pass through an opening in a first end support 546 and can pass through an opening in a second end support 548 spaced from the first end support 546. The first gate 584 and the second gate 588 can include a force transfer structure 544 connected to the first gate 584 and positioned separate from a rotational axis 575 of the shaft 576. In some embodiments, the force transfer structure 544 can be a rotatable element.

In embodiments of the container rack latch system 580, the first gate 584 and the second gate 588 in an extended position can protrude above the supporting surface 570 or above a set of container supports 574. The first gate 584 and the second gate 588 in a retracted position can be at or below the container support surface 570 (e.g., planes defined by the respective supports or surfaces) or at or below a first set of container supports 574.

The container rack latch system 580 in embodiments of the disclosure can further include a third gate 582, a fourth gate 586, and a shaft 578 rotatably connecting the third gate 582 with the fourth gate 586 and separating the third gate 582 from the fourth gate 586. The shaft 578 is fixedly coupled to the gates 582, 586, and allows for the gates 582, 586 to be simultaneously rotated between the extended and retracted positions as a pair. The shaft 578 can pass through an opening in a first end support 546 and can pass through an opening in a second end support 548 spaced from the first end support 546. The third gate 582 can include a force transfer structure 544 that can be connected to the third gate 582 and positioned separate from a rotational axis 575 of the shaft 578.

In embodiments of the container rack latch system 580, the third gate 582 and the fourth gate 586 in an extended position can protrude above the container supporting surface 570 or above a first set of container supports 574. The third gate 582 and the fourth gate 586 in a retracted position can at or below the container support surface 570 (e.g., planes defined by the respective supports or surfaces) or at or below a first set of container supports 574.

In embodiments of the disclosure, one or more of the gates of the container rack latch system 580 can have an uneven distribution of mass about the rotational axis (e.g. axis 575) of the shaft 576 that can result in rotation of the gates from a retracted position to an extended position in the absence of an external force applied to the gates to maintain them in the retracted position. In embodiments of the container rack latch system 580 of the disclosure the first gate 584 and the third gate 582 can have a distribution of mass about the rotational axes 575 of the shafts 576, 578 that can cause these gates 584, 582 to rotate from a retracted position with respect to the first end support 546 or support surface 570 to an extended position in the absence of an external force applied to the first and third gates 584, 582.

An embodiment of the disclosure can include a container transfer system 200. The container transfer system 200 can include a container transfer carriage 220 that has a container support surface 230 capable of receiving and transferring a container 460 along the container support surface 230 of the transfer carriage 220. The container transfer carriage 220 can have one or more manipulators 240 that can engage a container 460. The manipulator 240 can translate along a length of the container transfer carriage 220 and is adapted to translate the container 460 along the container support surface 230 of the transfer carriage 220. The container transfer system 200 can include a container rack latch system 580 connected to a rack 450. The rack latch system 580 and rack 450 can house various containers 460 within each level and on one or more levels. The various containers 460 can also be retrieved from the rack 450 and rack latch system 580. The rack latch system 580 includes gates (e.g. gates 584, 588), and supports 510 having a supporting surface 570. The rack 450 and rack latch system 580 are configured to receive and store one or more of the containers (e.g., containers 460, 464, or the like) on the supporting surface 570 or a set of container supports 574. A container 460 can be positioned between the gates of the container rack latch system 580 and containers 460 can also be positioned along ungated portions of the rack 450. The container transfer system 200 can include a latch actuator mechanism 290 that retracts and extends the gates (e.g. gates 584, 588) of the container rack latch system 580. The container transfer carriage 220 and the latch actuator mechanism 290 can operate cooperatively to load the container 460 from the container transfer carriage 220 onto the supporting surface 570 of the container rack latch system 580. The container transfer carriage 220 and the latch actuator mechanism 290 can also operate cooperatively to unload the container 460 from the supporting surface 570 to the carriage 220.

In some embodiments of the container transfer system 200 the latch actuator mechanism 290 can be moved towards the gates and away from the transfer carriage 220 and the latch actuator mechanism 290 can also be moved away from the gates and towards the transfer carriage 220. The latch actuator mechanism 290 can be mounted to the container transfer carriage 220. The latch actuator mechanism 290 can be mounted to the container rack latch system 580. The movement of the carriage manipulator 240 can be independent from the movement of the latch actuator mechanism 290.

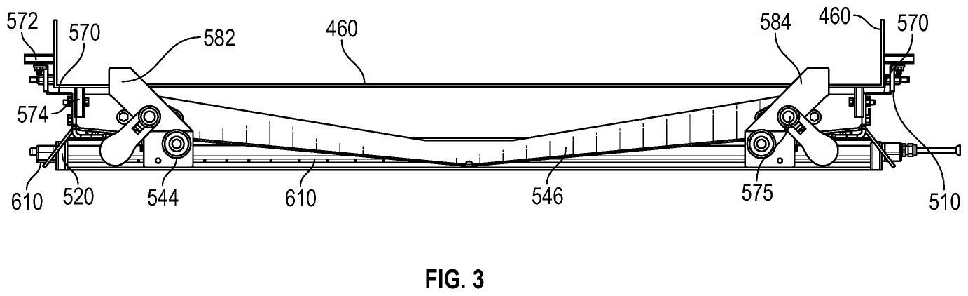

FIG. 1 illustrates a container rack latch system 580 in an embodiment of the disclosure that can include a gate 584 in an extended position at a proximal end 554 of the system 580 and a gate 588 in an extended position that can be spaced by more than the length of the container 460 from the gate 588 at the proximal end 554 of the system 580. In an extended position the first gate 584 and the second gate 588 can protrude above the container supporting surface 570 or above a first set of container supports 574. The space between the gates 584, 588 can be sized to accommodate a container 460 without the container 460 touching either of the gates 584, 588 in the extended position. For example, the gates 584, 588 can be near to opposing ends of the container 460 without being in physical contact with the container (e.g. container 460 in FIG. 12). The gates 584, 588 can be linked by a rotatable latch shaft 576. As shown in FIG. 1, the container rack latch system 580 can include other pairs of gates (e.g. gates 582, 586) at the proximal end and spaced from the proximal end that can be linked by shaft 578. The container rack latch system 580 can have one or more spacing members or end support 546, 548. Spacing members or end supports 546, 548 can be positioned within the rack to the support gates, separate one or more shafts 576, 578, and permit rotation of the gates and shafts. The spacing members or end supports 546, 548 can be located between opposing supports 510. The spacing members or end supports 546, 548 can be connected to the supports 510, the rack framing members, or a combination of these. As shown in FIG. 3, the container rack latch system 580 can have one or more container supports 510 and the container supports 510 can have a container support surface 570. In some embodiments the container supports 510 can have openings 520 to support lighting lamps 610 in addition to a container supporting surface 570. A container 460 can be translated on the container supports 510 on either side of the rack latch system 580 and rack 450 as illustrated in FIG. 1. In some embodiments of the rack latch system 580, as shown in FIG. 3, each of the light and container supports 510 can further include a first set of container supports 574 and second set of container supports 572 rotatably coupled to the light and container supports 510. The container support 510 and optional light support can be mounted or fixtured to framing members of a rack or tower 450. The supports 510 can be spaced apart by spacing members or end supports 546, 548 and connected to the rack 450. The separation between the supports 510 can be slightly more than the width of the containers 460 to allow movement of containers 460 within the rack latch system 580. The gates can include a force transfer structure 544 on the gate 584 that is spaced from a rotational axis 575 of the rotatable shaft 576. A latch actuator mechanism 290, which can optionally have a lever arm 292 or other engagement mechanism, can interact with the force transfer structure 544 on the gate 584 and can operate to move the gates 584, 588 from the extended position above container support surface 570 or above a first set of container supports 574 to the retracted position (below surface 570 or below a first set of container supports 574 (FIG. 1 and FIG. 2). In some embodiments the gates can have a distribution of mass about the rotational axis of the shaft, for example the rotation axis 575 of the shaft 576 connected to gate 584, such that the greater distribution of mass on one side of the rotation axis 575 can cause the gate 584 to rotate from a retracted position with respect to the first end support 546 to an extended position (see FIG. 2) in the absence of an external force applied to the force transfer structure 544 by the latch actuator mechanism 290.

FIG. 2 illustrates the container rack latch system 580 of FIG. 1 in an embodiment of the disclosure wherein the gates 582, 584, 586, 588 are in retracted positions. In a retracted position the gate 582, 584, 586, 588 can be at or below container support surface 570 or even with or below a top surface of the first set of container supports 574. FIG. 2 illustrates action of a lever arm 292 of the latch actuator mechanism 290 against the force transfer structures 544 on the gates at the proximal end 554 that results in positioning the one of more pairs of linked gates (gates 582 and 586, gates 584 and 588) in the retracted position. With the one or more linked gates (gates 582 and 586, gates 584 and 588) in the retracted position the container 460 is unobstructed and free to move or be translated along the container support surfaces 570.

FIG. 3 illustrates a front view of the container rack latch system 580 with container 460 contacting a first set of container supports 574 and second set of container supports 572. The gates 582, 584 are in the extended position and restrict movement of the container 460 away from a position between the gates 582, 586 (not show) and gates 584 and 588 (not shown). The container rack latch system 580 can have one or more container supports 510 and the container supports 510 can have a container support surface 570 or supports 574. In some embodiments the container supports 510 can have openings 520 to support lighting lamps 610 in addition to a container supporting surface 570 or 574.

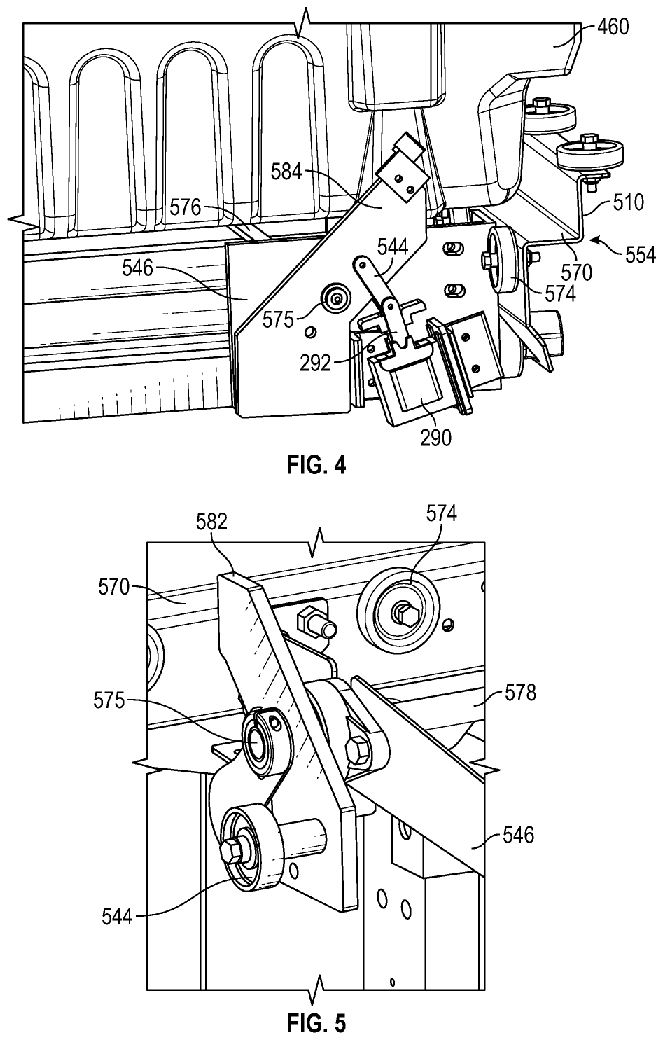

FIG. 4 illustrates an embodiment of the disclosure having an electromagnetic or pneumatic latch actuator mechanism 290 connected to the container rack latch system at a proximal end 554 of the container rack latch system 580. The latch actuator mechanism can optionally have a lever arm 292 or other engagement mechanism that can interact with the force transfer structure 544 on the gate 584. The latch actuator mechanism 290 can operate to move the gate 584 between the extended position (above container support surface 570 or above a first set of container supports 574) and the retracted position (not shown, but at or below surface 570, or at or below a first set of container supports 574). The gate 584 in the extended position shown can restrict translation of container 460 past the gate 584 along the container support surface 570. The gate 584 in the retracted position (not shown) can permit translation of container 460 past the gate 584 along the container support surface 570. Gate(s) 584 can be linked by a rotatable shaft 576 having a rotational axis 575; the rotatable shaft 576 can be linked to another gate such as 586 (not shown). In some embodiments of the disclosure the rotatable shaft(s) 576 can be eliminated using two or more electromagnetic and/or pneumatic latch actuator mechanisms 290 positioned at the proximal end of the rack latch 580 to act on corresponding gates (e.g. gates 582 and 584) and two or more latch actuator mechanisms can be positioned spaced from the proximal end of the rack latch 580 to act on corresponding gates (e.g. gates 586, 588). The electromagnetic and/or pneumatic latch actuator mechanisms at the front and rear of the rack latch can be electronically or pneumatically coupled to extend and retract together.

FIG. 5 illustrates in greater detail aspects of a proximal gate 582 in an extended position with a portion above the support surface 570 or above a first set of container supports 574. The first end support 546 with an opening for shaft 578 in embodiments of the disclosure are also illustrated.

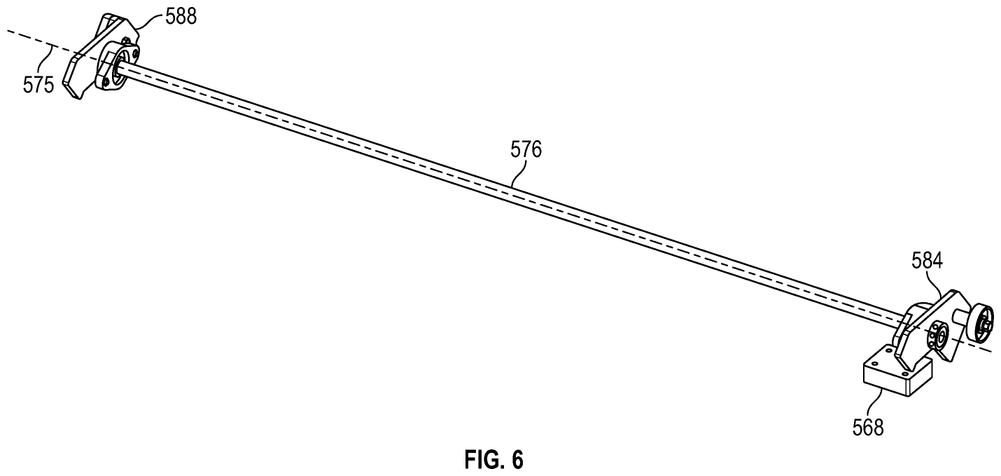

FIG. 6 illustrates aspects of retracted separated gates 584, 588 linked by a rotatable shaft 576 having a rotational axis 575 in embodiments of the disclosure. Optionally a stop 568, which can be a plate (shown) or a feature of the first end support 546, can be positioned in the container rack latch system 580 to limit rotation of the gates 584, 588. In FIG. 6 a portion of gate 584 is shown contacting plate 568.

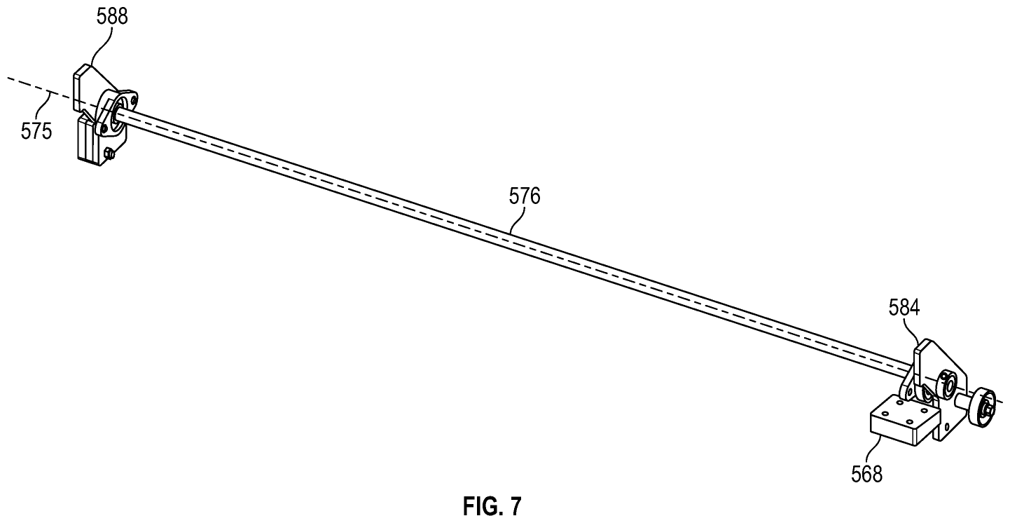

FIG. 7 illustrates aspects of extended separated gates 584, 588 linked by a rotatable shaft 576 having a rotational axis 575 in embodiments of the disclosure. Gate 584 in the extended position does not contact plate 568.

FIG. 8 illustrates a side view of rack or tower 450, and a container 464 positioned within the rack or tower 450 on container support surface 570. A latch actuator mechanism 290 is shown position below the carriage 220 and positioned at or behind a plane (e.g. plane 226) including the front face of the carriage 220. The latch actuator mechanism 290 can extend out from below the carriage 220 toward the rack 450 and rack latch 580 (not shown) to engage and retract the gates (e.g. gates 582 and 584 (not shown)). The latch actuator mechanism 290 can be mounted to a transfer carriage 220. FIG. 8 further illustrates an embodiment of a rack 450 and rack latch 580 having a sloped container supporting surface 570, the container supporting surface 570 a distance (d2) from a horizontal surface 470 near the second end support 548 (FIG. 1) wherein (d2) is greater than a distance (d1) from the support surface 570 to the horizontal surface 470 near the first end support 546 (FIG. 1). The containers 460, 446 can have mateable fluid fittings 440, 452, 442 to permit the containers 460, 446 to be fluidly coupled relative to each other.

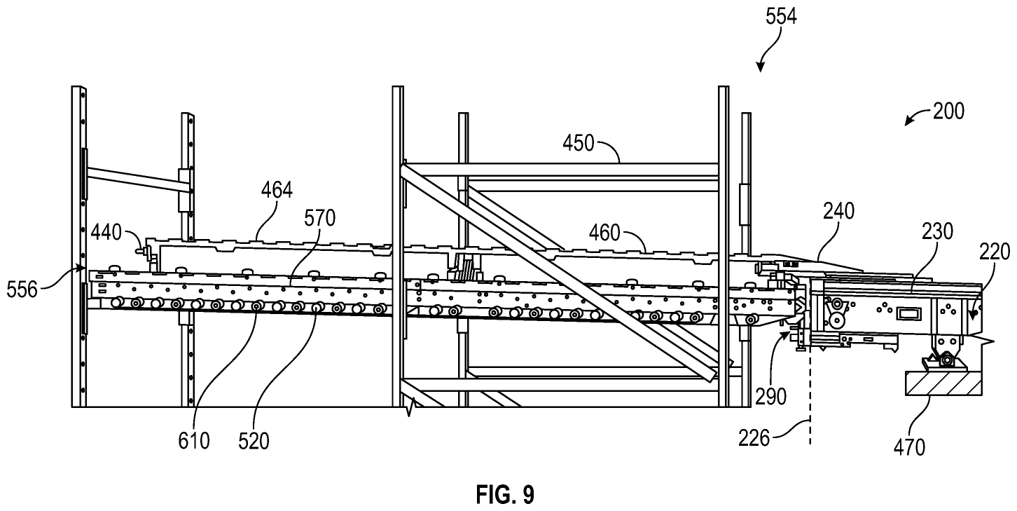

FIG. 9 illustrates a side view of rack or tower 450 and transfer carriage 220 of FIG. 8. Two containers 460, 464 are shown positioned within the rack or tower 450 on container support surface 570. Container 460 is near the proximal or front end 554 of the rack 450 and rack latch system and container 464 is positioned outside of the container rack latch system and towards a rear or distal end 556 of the rack 450. The latch actuator mechanism 290 positioned below the carriage 220 is shown in the extended position past from the front edge or face 226 of the carriage 220. In this position the latch actuator mechanism 290 can engage the gates (e.g. gates 582 and 584 (not shown)) causing them to be retracted and thereby allowing container 460 to be loaded onto the support surface 570 by a force applied by the one or more manipulator(s) 240 of the transfer carriage 220. The force applied by the manipulator(s) 240 can also translate container 464 further into the rack 450. The latch actuator mechanism 290 can be withdrawn from contact with the one or more gates by retracting the latch actuator mechanism 290 back to the position at or behind the plane including the front face (e.g. face 226) of the carriage 220 as shown in FIG. 8. Once the latch actuator mechanism is withdrawn the retracted gates (e.g. gates 582 and 584 (not shown)) can rotate back into an extended position and thereby prevent movement of the container 460.

In embodiments of the disclosure where the latch actuator mechanism 290 is separate from the gate or rack latch system 580, for example where it is mounted to a transfer carriage 220, the latch actuator mechanism 290 can be translated back and forth across front face plane 226 of the transfer carriage 220 using a motor, a piston, or suitable gears to engage the force transfer structure of the gate.

FIG. 8 and FIG. 9 further illustrate aspects of a container transfer system 200 in embodiments of the disclosure. The container transfer system 200 can include a container transfer carriage 220, the container transfer carriage 220 includes a container supporting surface 230 capable of receiving and transferring a container 460 along the container support surface 230 of the transfer carriage 220. The transfer carriage 220 can have one or more manipulators 240 that can engage surfaces of the container 460. The manipulators 240 can translate along a length of the container transfer carriage 220. Manipulator(s) 240 engaged with the surfaces of the container 460 are adapted to translate the container 460 along the supporting surface 230. The container transfer system 200 can further have a latch actuator mechanism 290 that retracts and extends gates of a container rack latch system 580 connected to a rack or tower 450. The rack 450 can be configured to removably receive one or more of the containers (e.g., containers 460, 464, or the like) between extendable and retractable gates and on a supporting surface 570 of the container rack latch system 580. The container transfer carriage 220 and the latch actuator mechanism 290 of the container transfer system 200 can operate cooperatively to load the container 460 from the container transfer carriage 220 to the supporting surface 570 and operate cooperatively to unload the container 460 from the supporting surface 570 to the container transfer carriage 220. The container transfer system 200 can include a latch actuator mechanism 290 that reversibly moves towards and away from the carriage 220 as illustrated in FIG. 8 and FIG. 9. The movement of the transfer carriage manipulator 240, for example retracted in FIG. 8 or extended in FIG. 9, can be independent from the movement of the latch actuator mechanism 290. In some embodiments of the container transfer system 200 as illustrated in FIG. 4, the latch actuator mechanism 290 can be mounted to the container rack latch system 580. In embodiments of the container transfer system 200 the container supports 510 can have a container support surface 570 or container supports 574. In some embodiments the container supports 510 can have openings 520 to support lighting lamps 610.

FIGS. 10 through FIG. 21 illustrate schematically embodiments of the disclosure showing non-limiting gate positions in a rack latch system after engagement with the one or more latch actuator mechanisms (not shown) that can extend and retract gates of the container rack latch system 580. FIG. 10 to FIG. 21 also illustrate schematically the position of one or more containers in the container rack latch system within the rack, and the coupling and decoupling of containers. The one or more manipulators 240, which can be part of a transfer carriage 220, can engage container 460 surfaces and apply force to one or more containers 460 within the container rack system to transfer or translate the containers 460 into, out from, and within the rack 450 along the container support 570 (e.g. see also FIG. 8 and FIG. 9). The containers (e.g., containers 460, 464, or the like) can include mateable fluid fittings 440, 452, 442 that can be used to fluidly couple the containers 460 together. Spacing members or end supports 546, 548 can be positioned within the rack and rack latch system to support the gates and the one or more shafts 576, 578, and permit rotation of the gates and shafts 576, 578. The space between the gates (gates 584, 588 and gates 582, 586) can be sized to accommodate a container 460 without the container touching either of the gates in the extended position. In some embodiments of the disclosure, opposing gates at the proximal end and those gates spaced from the proximal end of the rack (e.g. rack 582, 586) can be rotatably linked together. In some figures, for example FIG. 17, the partial container 466 is omitted for clarity. The direction of force applied by the one more manipulators 240 to the containers 460 is shown by the arrow symbol (→) or (←) in the figures where present.

The top-down views shown in FIG. 10 through FIG. 21 also illustrate aspects of a container transfer system 200 similar to the side views shown in FIG. 8 and FIG. 9 where the containers 460 can be loaded, unloaded, and translated along the support surface 570 of support 510 within the rack and/or container rack latch system 580. The container transfer system 200 can include a rack 450 having supporting surface 570. A container 460 can be engaged by manipulator(s) 240 from a transfer carriage 220 (details not shown) and translated along the supporting surface 570 and past retracted gates (gates 582, 584, and gates 586, 588) and first and second end supports 546, 548. The container 460 engaged by manipulator(s) 240 can be removed from the support surfaces 570 and onto the transfer carriage 220 container support surface 230.

The gates (e.g. gates 584, 588, gates 582, 586, or the like) in embodiments of the disclosure as illustrated in FIGS. 10 to 21 can be linked together in pairs (e.g. gates 584, 588, gates 582, 586, or the like) whereby the gates of a pair can move and thereby extend or retract together. In some embodiments of the disclosure the gates in a pair can be linked physically or electronically and thereby move between the extended or retracted position together. In some other embodiments of the disclosure the gates in a pair can be linked physically by a rotatable latch shaft 576, 578. The pairs of gates can be actuated to rotate in opposing directions to achieve the desired retracted or extended position. For example, as illustrated in FIG. 1, the gates 582, 586 can rotate in a clockwise direction and the gates 584, 588 can rotate in a counterclockwise direction to be positioned in the retracted position, and rotate in the counterclockwise and clockwise directions, respectively, to be positioned in the extended position.

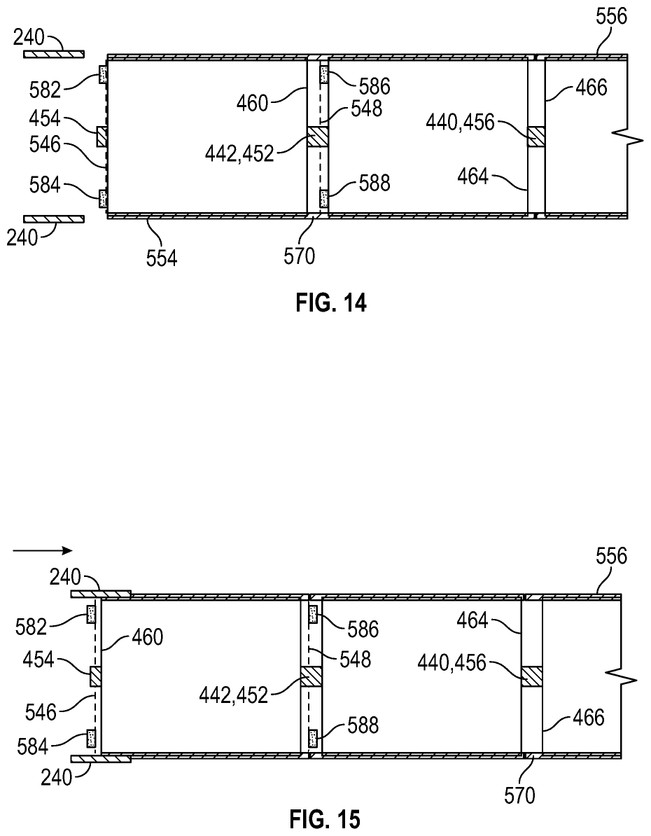

The various manipulator 240 and latch actuator mechanism 290 steps or acts depicted in FIGS. 10-21 can be combined in any order and steps or acts repeated as needed to: load containers 460 into the rack and support surface 570 from a carriage 220, transfer or translate containers 460 within the rack latch system and the rack along the support surface 570, remove or unload containers 460 on the support surface 570 from the rack and rack latch system, and decouple the containers 460 from each other. The following sequences depicted in the FIGS. 10-21 are non-limiting examples of some of these combinations. For example, container 460 can be loaded into the rack 450 and rack latch system onto the supporting surface 570 as depicted sequentially including but not limited to aspects described and shown in FIG. 17, FIG, 18, FIG, 19, FIG. 10, and FIG. 11. In another example, container 460 can be unloaded or removed from the rack 450 and rack latch system and container supporting surface 570 as depicted sequentially including but not limited to aspects described and shown in FIG. 14, FIG. 15, FIG. 16, FIG. 18, FIG. 19, FIG. 20, and FIG. 21.

FIG. 10 is a schematic illustration of a top-down view of a rack 450 and rack latch system having supporting surfaces 570 in embodiments of the disclosure showing containers 460, 464 translated by the manipulators 240 (see also arrow >for direction of translation) from the proximal end of the rack toward an end of the rack separated from the proximal end along container support surfaces 570 on opposite sides of the rack. The manipulator 240 applies a force to the containers 460, 464 to translate them into the rack latch system and within the rack. The gates (gates 582, 584, and gates 586, 588) can be acted on by one or more latch actuator mechanisms 290 (not shown). The gates in FIG. 10 are illustrated in an open or retracted position (solid fill) with the containers illustrated passing over the gates. Both containers 460, 464 are shown passing over the retracted gates. FIG. 10 further illustrates end supports 546, 548 of the rack latch system 580 that can separate the gates on the rack.

FIG. 11 is a schematic illustration of a top down view of a rack 450 having container supporting surface 570 showing containers 460, 464 held by the manipulators 240 along the supporting surface 570. Container 460 is shown positioned between the extended gates 586, 588 spaced from the extended proximal gates 582, 584. A distal surface of container 460 is shown in contact with the extended gates 586, 588. The gates can be configured in the extended position by removing the latch actuator mechanism 290 from engagement with the gates or a force transfer structure on the gates. The gates in the extended position (small grid fill) restrict or block further translation of the container 460 along the supporting surface 570.

FIG. 12 is a schematic illustration of a top down view of a rack 450 having supporting surface 570 in embodiments of the disclosure showing container 460 positioned by the manipulators 240 between the gates (gates 582, 584, and gates 586, 588) where neither end of the container 460 are in contact with the gates in an extended position (small grid fill). The container in FIG. 11 can be positioned as shown in FIG. 12 by applying a pulling force (←) to the container 460 in FIG. 11 and moving it toward (as indicted by the arrow) the front/proximal end 554 of the rack with the one or more manipulator(s) 240. Container 464 can also be pulled forward by application of the pulling force to the container 460. Fluid fittings 442, 452 of the containers 460, 464, respectively, are illustrated as being coupled together in FIG. 12 (see also FIG. 9).

FIG. 13 is a schematic illustration of a top down view of a rack 450 and rack latch system 580 within the rack 450, the rack latch system 580 having a first end support 546 and a second end support 548 spaced from the first end support 546 and supporting surfaces 570 connected to sides of the rack 450. FIG. 13 illustrates the gates a retracted or opened position compared to their extended or closed position depicted in FIG. 12. The gates (gates 582, 584, and gates 586, 588) can be retracted by engaging the latch actuator mechanism 290 (not shown) with the gates. The container 460 is shown positioned by the manipulator(s) between the pairs of gates. The container 460 is shown free of contact with any of the gates. The fluid fittings 442, 452 of container 460 and 464 are fluidly coupled together with the gates in the retracted position. Container 464 is shown positioned within the rack 450 and along supports 570. Container 464 is positioned past the second end support.

FIG. 14 is a schematic illustration of a top down view of a rack 450 having supporting surfaces 570 that shows the container 460 positioned between the gates (gates 582, 584, and gates 586, 588) which are in an extended or closed position (indicated with small grid fill). A front or proximal surface of container 460 contacts one or both of gates 582, 584. The one or more manipulator(s) 240 are shown disengaged from the container (460). With the manipulator(s) 240 disengaged from the container 460, the slope of the supporting surface 570 can allow the containers 460 in the rack 450 to move toward the proximal end of the rack 450 via gravity. As a result, container 460 can shift to the front of the rack latch system and contact gates 582, 584 and container 464 can shift toward the gates 586, 588 near the back of the container rack latch system. As illustrated, container 460 can be fluidly mated with container 464 via fluid fittings 442, 452, container 464 can be fluidly mated with container 466 via fluid fittings 440, 456, and so on.

FIG. 15 is a schematic illustration of a top-down view of a rack 450 having supporting surface 570 with the container 460 pushed away from contact with extended gates 582, 584 (as shown in FIG. 14) by applying a force (→) to container 460 by one or more manipulator(s) 240 engaged with container 460 surfaces. As shown in FIG. 15, after application of the force by the manipulator 240 engaged with the container 460, the container 460 can be positioned between extended gates (gates 582, 584, and gates 586, 588) and can be free of contact with any of the gates. As shown in FIG. 15, container 464 is also positioned away from gates 586, 588 in the extended position. Containers 460, 464 remain fluidly coupled via fluid fittings 442, 452.

FIG. 16 is a schematic illustration of a top-down view of a rack 450 having container supporting surfaces 570 that depicts the container 460 engaged by manipulator(s) 240, and container 464 fluidly connected with container 460, both being translated along the container supporting surfaces 570 and past retracted gates (gates 582, 584, and gates 586, 588). The container 460 is translated toward the proximal end of the rack 450 on the supporting surface 570 by a force (←) applied by the manipulator(s) 240. This translation can take place for example after retraction of the gates from their extended position with the container 460 positioned as illustrated in FIG. 15. The manipulators 240 can translate the containers 460 away from the rack 450 and the rack latch system 580 and onto transfer carriage 220 and container support surface 230 (not shown).

FIG. 17 is a schematic illustration of a top-down view of a rack 450 and rack latch system having supporting surface 570, gates, and first and second end supports 546, 548 showing the container 460 engaged by manipulator(s) 240. The container 460 in FIG. 17 is shown being loaded into the rack 450 and onto container supporting surfaces 570 from a transfer carriage 220 (not shown, but see FIG. 8). The one or more manipulator(s) 240 apply a force (♭) to the container 460 that translates the container 460 into the rack 450. The gates 586, 588 are in an extended position and can act as a back stop to facilitate engagement of the fluid fitting 442 on container 460 with the fluid fitting 452 on container 464 to form mated inlet and outlet fittings between the containers 460, 464. As illustrated, when gates 586, 588 are in an extended position and acts as a stop, the distal end of container 464 contacts the gates 586, 588 in the extended position to facilitate this mating. The gates 586, 588 in the extended position allows the manipulator 240 to push the container 460 with the fluid fitting 442 into container 464 with the fluid fitting 452 which can fluidly mate or couple the two containers 460, 464.

The top-down view of the container transfer system 200 in FIG. 17 is similar to the side view of the container transfer system depicted in FIG. 8. The container transfer system 200 can include a rack 450 and a rack latch system 580 having one or more container supporting surfaces 570 on opposing sides on the interior of the rack 450, one or more gates, and first and second end supports 546, 548. The container 460 can be engaged by manipulator(s) 240 and loaded onto support surfaces 570 from the container support surface 230 (below container, not shown) of a transfer carriage 220 (not shown). As shown in FIG. 17, the container 460 engaged by manipulator(s) 240 can be moved from the transfer carriage 220 and container support surface 230 into the rack 450 once one or more of the gates (gates 584, 588 and/or gates 582, 586) have been opened (see FIG. 10).

FIG. 18 is a schematic illustration of a top-down view of a rack 450 having supporting surface 570 showing mated/fluidly coupled containers (e.g. containers 460 and 464 in FIG. 18) engaged by manipulator(s) 240. The one or more manipulator(s) 240 apply a force (←) in the direction away from the rack 450 and towards the carriage transfer surface 230. The force translates the mated containers 460, 464 away from contact with extended gates 586, 588 into a position where container 464 is between the gates 584, 588 and free of contact with the gates 584, 588.

FIG. 19 is a schematic illustration of a top down view of a rack 450 having supporting surface 570 showing the container 460 engaged by one or more manipulator(s) 240. Container 464 is shown positioned between the gates (gates 582, 584, and gates 586, 588). The gates are illustrated in a retracted position, having been retracted by engagement of a latch actuator with the gates. Container 460 and container 464 are shown fluidly mated via fluid fittings 442, 452. Manipulator(s) 240 can apply a force to the mated containers 460, 464 to translate container 460 into the rack 450, as depicted in FIG. 10.

FIG. 20 is a schematic illustration of a top down view of a rack 450 having supporting surface(s) 570 with gates (gates 584, 588, and gates 582, 586) in an extended position. FIG. 20 illustrates the container 460 engaged by manipulator(s) 240 being pulled toward the container transfer carriage 220 for removal from the rack 450 (compared with FIG. 19); container 464 is retrained between the gates. Container 460 is shown fluidly mated with container 464 and the two containers 460, 464 are translated by the force applied by the manipulator(s) 240 until container 464 contacts the front or proximal gates 582, 584 which are extended.

FIG. 21 is a schematic illustration of a top down view of a container transfer system 200. The container transfer system 200 can include a rack 450 having one or more supporting surface(s) 570, first end support 546 and second end support 548, and pairs of gates (gates 584, 588, and gates 582, 586). FIG. 21 depicts container 460 engaged by manipulator(s) 240 of a container transfer carriage (220) being removed from the rack 450 and positioned onto the container support surface 230 of the transfer carriage 220. Container 460 and container 464 can be separated from each other by gates 582, 584 being in the extended position and by having container 460 on the transfer carriage 220 and container 464 within the container rack latch system 580 and between pairs of gates. Container 460 and fluid fitting 442 can be unmated or fluidly decoupled from container 464 and fluid fitting 452 by the force (see arrow (←)) applied from the manipulator(s) 240 to container 460 and by restriction of further translation of container 464 in contact with the extended gates 582, 584. Fluid fittings 442, 452 of the containers 460, 464, respectively, can be uncoupled as shown.

Aeroponic farming methods of plant production generally involves spraying a liquid nutrient solution on the roots of developing plants protruding through a growth media. In hydroponic farming for plant production, developing plants can be positioned in rafts with openings and the roots of developing plants suspended into a solution of nutrient-rich, oxygenated water. In both aeroponic and hydroponic methods, the plants are supplied with light from a suitable source above the plants to promote photosynthesis and plant development.

In some embodiments of the disclosure the container can be a growing container that includes one or more developing plants, germinating, and/or germinated seeds. The rack 450 can be part of an aeroponic or hydroponic system. Embodiments of the disclosure can include methods of using the container transfer system to accurately position containers within racking systems as well as aeroponic and/or hydroponic grow systems, racks, and towers.

Embodiments of the disclosure can include a method of container transfer system 200 operation that can include the acts or steps of transferring a container 460 between a supporting surface 230 of a container transfer carriage 220 and a support surface 570 of a container rack latch system 580. The container rack latch system can be positioned within a rack 450 and the container transfer carriage can include or comprise one or more manipulators 240. The method can include the acts or steps of sequentially or concurrently operating the one or more manipulators 240 of the container transfer carriage 220 and the container rack latch system 580 to load the container 460 from the container transfer carriage 220 onto the supporting surface 570.

Embodiments of the method of operating the container transfer system 200 can include a container transfer carriage 220 that can further include a latch actuator mechanism 290. The latch actuator mechanism 290 can be connected to the container transfer carriage below the carriage supporting surface 230. The latch actuator mechanism 290 can include one or more levers or latches 292 adapted to reversibly engage with and disengage from the one or more pairs of spaced gates 584, 588 of the container rack latch system 580. The action of the one or more levers can retract the gates 584, 588.

In embodiments of the method of operating the container transfer system, the one or more pairs of gates 584, 588 can be in an extended orientation protruding above a plane defined by the container supporting wall or surface 570, 574 (of the light and container support 510) or positioned in a retracted orientation extending below the plane defined by the supporting surface 570, 574. In the extended orientation, the one or more pairs of gates 584, 588 can restrict transferring of the container between the container transfer carriage 220 to the supporting surface 570, 574 within the rack 450. In the retracted orientation, the one or more pairs of gates 584, 588 enables transfer of the container between the container transfer carriage 220 onto the supporting surface 570 within the rack 450.

Embodiments of the disclosure can include a method of loading and unloading containers from a container transfer system 200. The method can include moving a container 460 engaged by one or more manipulators 240 of a container transfer carriage 220 onto or away from a container supporting surface 570 of a container rack latch system 580. In the method, the container can be moved from a first position between a pair of gates in an extended position wherein the container is touching at least one gate 584 at a proximal end 554 of the rack, to a second position where the container 460 is free of contact with the gate 584 and free of contact with the gate 588 with the gates in the extended position. The method can further include the act or step of retracting gates 584, 588 at or below the container supporting surface 570 and translating the container 460 to a third position along the supporting surface 570.

In embodiments of the disclosure the term fluid can refer to either a gas or a liquid. Liquids can include aqueous based solutions, organic solvents, and the like. In some embodiments the liquid can be a nutrient solution, water, or sanitizing solution for removing biofilms from hydroponic and aeroponic growing systems. In other embodiments the fluid can be a gas. The gas can be used for flushing, cleaning, or drying conduits and equipment surfaces.

The following clauses define particular aspects and embodiments of the disclosure.

Clause 1. A container rack latch system (580), comprising: a first gate (584) at a proximal end (554) of a rack (450) and a second gate (588) spaced from the proximal end of the rack, the gates (584, 588) configured to operate in an extended orientation (FIG. 1), said gates adapted to prevent transfer of a container (460) positioned on a container supporting surface (570 and/or 574) away from between the gates, and said gates further configured to operate in a retracted orientation (FIG. 2) wherein said gates are adapted to permit transfer of the container away from the rack latch system (580) or further into the rack (450) along the container supporting surface (570) and beyond the gates.

Clause 2. The container rack latch system (580) of clause 1 wherein the gates (584, 588) are configured to rotate between the retracted position and the extended position, said gates linked together by a shaft (576).

Clause 3. The container rack latch system (580), as in any one of clauses 1 or 2 further comprising a third gate and a fourth gate (582, 586) that are configured to operate between the retracted and extended positions, said third gate and fourth gates linked together by a shaft (578), the first and second gates (584, 588) separated from the third and fourth gates (582, 586) by a first end support (546) and a second end support (548) spaced from the first end support (546) in the rack latch system (580).

Clause 4. The container rack latch system (580) as in any one of clauses 1 to 3 wherein said container supporting surface (570 and/or 574) is sloped within the rack, said container supporting surface a distance (d2) from a horizontal surface (470) near the second end latch support (548), (d2) is greater than a distance (d1) from the support surface (570) to the horizontal surface (470) near the first end support (546, FIG. 8).

Clause 5. The container rack latch system (580) as in any one of clauses 1 to 4further comprising a force transfer structure (544) on the gate(s) (584); said force transfer structure spaced from a rotational axis (575) of the shaft (576) connecting pairs of gates.

Clause 6. A method of container rack latch system (580) operation, comprising: applying a first force (manipulator 240) to a first container (460) on the support surface (570 and/or 574) of the container rack latch system (580) to translate said first container to a position between gates (584, 588) of the container rack latch system, said gates in an extended position, and said container free from contact with said gates (e.g. FIG. 12 and FIG. 15); and, applying a second force (from latch actuator mechanism (290)) to a force transfer structure (544) on a proximal gate (584) of the container rack latch system (580) to move the proximal gate (584) and the linked opposing gate (588) from the extended position to a retracted position (FIG. 2, FIG. 13).

Clause 7. The method of container rack latch system (580) operation of clause 6 further comprising: applying a third force to the first container (460) to transfer said first container along the container support surface (570 and/or 574) of the container rack latch system (580) with the gates (584, 588) in the retracted position (e.g. FIG. 10 or FIG. 16).

Clause 8. The method of container rack latch system (580) operation as clause 7, wherein the transfer of the first container indexes a second container (464) out from between the gates in the retracted position (FIG. 10); positioning said second container (464) in a non-overlapping position with the gates (FIG. 13); and removing the second force whereby the gates move from the retracted to the extended position (e.g. FIG. 15).

Clause 9. The method of container rack latch system (580) operation as in any one of clauses 7 and 8 that further comprises removing the third force from the one or more containers with the gates in the extended position (e.g. FIG. 14) and contacting the containers with the gates.

Clause 10. The method of container rack latch system (580) operation as in clause 7 wherein said transfer comprises removing the first container (460) from the proximal end of the container rack latch system (580, e.g. FIG. 16).

Clause 11. The method of container rack latch system (580) operation as in any one of clauses 6 to 10 wherein the latch actuator mechanism (290) comprises a lever arm (292) that interacts with a force transfer structure (544) on the gates (584) to reversibly move the gates (584, 588) from the extended position (above container support surface (570 and/or 574) to the retracted position (at or below surface 570 and/or 574)) (FIG. 1 and FIG. 2).

Clause 12. The method of container rack latch system (580) operation as in clause 10 further comprising positioning said second container in a non-overlapping position between the gates (FIG. 19); extending the gates (FIG. 20); and, separating the first container (460) from the second container (464) that is between the extended gates (FIG. 21) in the container rack latch system (580) by moving the first container towards the container transfer carriage (220) with the manipulator(s) (240).

Clause 13. The method of container rack latch system (580) operation as in clause 12 wherein extending said gates from the retracted position to the extended position comprises disengaging the latch actuator mechanism (290) from the force transfer structure (544) on the proximal gate (584) of a latch system (580).

Clause 14. A method of container rack latch system (580) operation, comprising: applying a first force to a first container (460) to fluidly mate the first container with a second container (464) on the supporting surface (570 and/or 574) of the rack latch system (580), said second container between a first gate (584) in an extended position and a second gate (588) in an extended position, said application of the first force to the first container until a distal end of the second container (464) contacts the gate (588) spaced from the proximal ends (FIG. 17); removing the first applied force and positioning the second container (464) between the first gate (584) and the second gate (588) spaced from the proximal end, said second container (464) free of contact with gates (584, 588) (FIG. 18); and retracting the gates (584, 588) of the container rack latch system (580) (FIG. 19).

Clause 15. The method of container rack latch system (580) operation of clause 14 wherein the removing of the first applied force comprises applying a second force to the container (460) that is the reverse direction of the first applied force (FIG. 18).

Clause 16. The method of container rack latch system (580) operation as in any one of clauses 14-15 further comprising: applying a force (from latch actuator mechanism (290, not shown) to a force transfer structure (544) on a proximal gate (584) of the latch system (580) to move the first gate (584) and the second gate (588) from the extended position to a retracted position (FIG. 1 to FIG. 2).

Clause 17. The method of container rack latch system (580) operation as in any one of clauses 14-16 further comprising: translating the second container (464) and first container (460) along the container support (570).

Clause 18. The method of container rack latch system (580) operation as in any one of clauses 14 to 17 wherein the container supporting surface (570 and/or 574) is sloped, said container supporting surface a distance (d2) from a horizontal surface (470) near the second end support (548), wherein (d2) is greater than a distance (d1) from the support surface (570 and/or 574) to the horizontal surface (470) near the first end support (546, FIG. 8).

Clause 19. A container rack latch system (580) comprising: a first gate (584), a second gate (588), and a shaft (576) rotatably connecting the first gate with the second gate and separating the first gate (584) from the second gate (588), said shaft (576) passing through an opening in a first end support (546) and said shaft passing through an opening in a second end support (548) spaced from the first end support; and a force transfer structure (544) connected to the first gate (584), said force transfer structure positioned separate from a rotational axis (575) of the shaft (576).

Clause 20. The container rack latch system (580) of clause 19, wherein said force transfer structure (544) comprises a rotatable element.

Clause 21. The container rack latch system (580) as in any one of clauses 19 and 20 wherein the first gate (584) and the second gate are in an extended position above the container support surface (570).

Clause 22. The container rack latch system (580) as in any one of clauses 19 to 21 further comprising a third gate (582), a fourth gate (586), and a shaft (578) rotatably connecting the third gate with the fourth gate and separating the third gate (582) from the fourth gate (586), said shaft (578) passing through an opening in a first end support (546) and passing through an opening in a second end support (548) spaced from the first end support; and a force transfer structure (544) connected to the third gate (582) and positioned separate from a rotational axis of the shaft (578).

Clause 23. The container rack latch system (580) as in any one of clauses 19 to 22 wherein the first gate and the third gate have a distribution of mass about the rotational axis of the shaft (576, 578) that rotates the gates from a retracted position with respect to the first end support (546) to an extended position in the absence of an external force applied to the first and third gates.

Clause 24. A container transfer system (200), comprising: a container transfer carriage (220), said container transfer carriage comprises: a container support surface (230) capable of receiving and transferring a container (460) along the container support surface (230) of the transfer carriage (220) and a manipulator (240) that engages the container (460), said manipulator translates along a length of the container transfer carriage (220), said manipulator adapted to translate the container along the container support surface (230); a container rack latch system (580) connected to a rack (450), said rack latch system comprising gates (584, 588) and a supporting surface (570), said rack latch system (580) configured to receive one or more of the containers (460, 464, etc.) on the supporting surface (570 and/or 574) and between the gates of the container rack latch system (580); a latch actuator mechanism (290) that retracts and extends the gates (584) of the container rack latch system; wherein the container transfer carriage (220) and the latch actuator mechanism (290) operate cooperatively to load the container from the container transfer carriage onto the supporting surface (570) or onto a first set of container supports (574)) of the container rack latch system and wherein the container transfer carriage (220) and the latch actuator mechanism (290) operate cooperatively to unload the container from the supporting surface to the carriage.

Clause 25. The container transfer system of clause 24, wherein the latch actuator mechanism (290) reversibly moves towards and away from the carriage (220).

Clause 26. The container transfer system as in any one of clauses 24-25, wherein the latch actuator mechanism is mounted to the container transfer carriage.

Clause 27. The container transfer system as in any one clauses 24-26, wherein the movement of the manipulator(s) is independent from the movement of the latch actuator mechanism.

Clause 28. The container transfer system of clause 24 wherein the latch actuator mechanism is mounted to the container rack latch system.

Clause 29. The container transfer system as in any one of clauses 24-28 wherein the rack is a tower having multiple levels.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations. even if such combinations or permutations are not made express herein, without departing from the spirit and scope of the invention.

1. A container rack latch system (580), comprising:
a first gate (584) at a proximal end (554) of the system (580) and a second gate (588) spaced from the proximal end of the system, the gates (584, 588) configured to operate in an extended orientation wherein said gates are adapted to prevent transfer of a container (464) positioned on a container supporting surface (570) away from between the extended gates, and said gates further configured to operate in a retracted orientation wherein said gates are adapted to permit transfer of the container positioned on the container supporting surface away from the rack or further into the rack and beyond the gates.

2. The container rack latch system (580) of claim 1 wherein the gates (584, 588) are configured to rotate between the retracted orientation and the extended orientation, said gates linked together by a shaft (576).

3. The container rack latch system (580), as in claim 1 further comprising a third gate and a fourth gate (582, 586) that are configured to operate between the retracted orientation and the extended orientation, said third gate and fourth gate linked together by a shaft (578), the first gate and the second gate (584, 588) separated from the third gate and the fourth gate (582, 586) by a first end support (546) and a second end latch support (548) spaced from the first end support (546).

4. The container rack latch system (580) as in claim 1 wherein said container supporting surface (570) is sloped, said container supporting surface a distance (d2) from a horizontal surface (470) near the second end latch support (548), (d2) is greater than a distance (d1) from the support surface (570) to the horizontal surface (470) near the first end support (546).

5. The container rack latch system (580) as in claim 1 further comprising a force transfer structure (544) on the gate (584); said force transfer structure spaced from a rotational axis (575) of the rotatable shaft (576).

6. A method of container rack latch system (580) operation, comprising:
applying a first force (manipulator 240) to a first container (460) on the support surface (570) of the container rack latch system (580) of claim 1 and translating said first container to a position between gates (584, 588) in the container rack latch system, said gates in an extended position, and said container free from contact with said gates; and,
applying a second force (from latch actuator mechanism (290)) to a force transfer structure (544) on the first gate (584) of the container rack latch system (580) to move the first gate (584) and the second gate (588) from the extended position to a retracted position.

7. The method of container rack latch system (580) operation of claim 6 further comprising: applying a third force to the first container (460) to transfer said first container along the container support surface (570) of the container rack latch system (580) with the gates (584, 588) in the retracted position.

8. The method of container rack latch system (580) operation as claim 7, wherein the transfer of the first container indexes a second container out from between the gates in the retracted position; positioning said second container in a non-overlapping position with the gates; and removing the second force whereby the gates move from the retracted to the extended position.

9. The method of container rack latch system (580) operation as in any one of claim 8 that further comprises removing the third force from the one or more containers with the gates in the extended position.

10. The method of container rack latch system (580) operation as in claim 7 wherein said transfer comprises removing the container (460) from the proximal end of the container rack latch system (580).

11. The method of container rack latch system (580) operation of claim 10 wherein the latch actuator mechanism (290) comprises a lever arm (292) that interacts with the force transfer structure (544) on the gates (584, 588) to move the gates (584, 588) from the extended position to the retracted position.

12. The method of container rack latch system (580) operation as in claim 10 wherein the container (460) from the proximal end of the container rack latch system (580) further comprises, positioning a distal end of container (460) and a second container in a non-overlapping position with the first gate (584); extending the first gate; and, separating the container (460) from the container (464) that is between the extended gates in the container rack latch system (580).

13. The method of container rack latch system (580) operation as in claim 12 wherein extending said gates from the retracted position to the extended position comprises disengaging the latch actuator mechanism (290) from the force transfer structure (544) on the proximal gate (584) of a latch system (580).

14. A method of container rack latch system (580) operation, comprising:
applying a first force to move a first container (460) to fluidly mate the first container with a second container (464) on the supporting surface (570, 574) of the rack latch system (580), said second container between a first gate (584) in an extended position and a second gate (588) in an extended position, applying said first force until a distal end of the second container (464) contacts the gate (588) in the rack latch system;
removing the first applied force and positioning the second container (464) between the first gate (584) and the second gate (588), said second container (464) free of contact with gates (584, 588); and,
retracting the gates (584, 588) of the container rack latch system (580).

15. The method of container rack latch system (580) operation of claim 14 wherein the removing of the first applied force comprises applying a second force to the container (460) that is the reverse direction of the first applied force.

16. The method of container rack latch system (580) operation of claim 14 further comprising: applying a third force from a latch actuator mechanism (290) to a force transfer structure (544) on a proximal gate (584) of the container rack latch system (580) to move the first gate (584) and the linked second gate (588) from the extended position to a retracted position.

17. The method of container rack latch system (580) operation of claim 14 further comprising: translating the second container (464) and first container (460) along the container support (570).

18. The method of container rack latch system (580) operation of claim 14 wherein the container supporting surface (570, 574) is sloped, said container supporting surface a distance (d2) from a horizontal surface (470) near the second end latch support (548) wherein (d2) is greater than a distance (d1) from the support surface (570) to the horizontal surface (470) near the first end support (546).

19. A container rack latch system (580) comprising:
a first gate (584), a second gate (588), and a rotatable shaft (576) connecting the first gate with the second gate and separating the first gate (584) from the second gate (588), said shaft (576) passing through an opening in a first end support (546) and said shaft passing through an opening in a second end support (548) spaced from the first end support; and,
a force transfer structure (544) connected to the first gate (584), said force transfer structure positioned separate from a rotational axis (575) of the rotatable shaft (576).

20. (canceled)

21. The container rack latch system (580) of claim 19 wherein the first gate (584) and the second gate are extendable to a position above a top surface of the first end support (546) the second end support (548) spaced from the first end support.

22. (canceled)

23. (canceled)

24. (canceled)

25. (canceled)

26. (canceled)

27. (canceled)

28. (canceled)

29. (canceled)
